(19) United States
(12) Patent Application Publication
(10) Pub. No.: US 2014/0196570 A1
(43) Pub. Date: Jul. 17, 2014

(54) Lightened Rotating Member and Method of Producing Same

(71) Applicant: FTS INTERNATIONAL, Fort Worth, TX (US)

(72) Inventors: Tony M. Small, Fort Worth, TX (US); Pankaj Patel, Fort Worth, TX (US)

(73) Assignee: FTS INTERNATIONAL, Fort Worth, TX (US)

(21) Appl. No.: 13/740,989

(22) Filed: Jan. 14, 2013

(51) Int. Cl. F16C 3/06; B23P 17/00

(52) U.S. Cl. CPC F16C 3/06; B23P 17/00
USPC 74/603; 29/592; 29/428

(57) ABSTRACT

A lightened rotating member for a machine. The lightened member includes a plurality of radially machined penetrations within at least one main bearing support journal of the rotating member. The plurality of penetrations is formed around the circumference of the main bearing journal face, with the penetration centerline directed radially toward the rotating member's axial centerline. An even number of penetrations may be utilized with minimal adverse effect on the balance of the rotating member. Odd numbers of penetrations may require subsequent rebalancing. The rotating member may be any rotating member that utilizes one or more main bearing support journals.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to reciprocating positive-displacement pumps and engines and, more specifically, to lightened rotating members within positive displacement pumps and engines and methods of producing same.

2. Description of Related Art including information disclosed under 37 CFR 1.97 and 1.98

Horizontal drilling and well stimulation processes have revolutionized the oil and gas industry with regard to the optimization of hydrocarbon extraction. Shale areas once thought unreachable are now within range of the horizontal drilling technology, with most shale gas wells having an average depth from the surface of between 7,500 and 13,000 feet with a horizontal run in the pay zone of 2,000 to 3,000 feet on average, if not better. Further, wells in shale areas that were once thought to be dry or of limited productivity are now capable of efficient (and profitable) production due to the use of advanced stimulation processes, specifically hydraulic fracturing of the well bore in the specific hydrocarbon zones.

Every shale zone is composed differently, requiring somewhat different drilling and well stimulation techniques to make the well economically viable. Because of the attendant high costs of horizontal drilling, it is necessary that such a well produce as much hydrocarbon as possible in as short of a time as possible to allow the well operator to recover these enormous upfront costs. As such, hydraulic fracturing is used quite extensively to open up the pores in the surrounding shale to allow trapped hydrocarbons to flow freely.

Rock pressures beneath the earth's surface are quite extreme, especially given the depths to which the well holes must be drilled to reach the pay zones. As a rule of thumb, the pressures exerted by the surrounding rock at a depth of 10,000 feet measures approximately 10,000 PSI, but can be as high as 15,000 PSI or greater depending on the shale characteristics. When a well hole is drilled to this depth, this enormous pressure is felt on the walls of the lateral run. Consequently, to fracture the surrounding shale formation requires the ability to exceed this surrounding pressure.

Hydraulic fracturing pumps, or “frac pumps” as they are known in the industry, are relatively massive positive displacement pumps capable of countering this enormous pressure at these extreme depths. Fracturing fluid (“frac fluid”), often containing proppants and/or slickwater, are pumped downhole by the frac pump, relying on the relative incompressibility of the frac fluid to transmit the frac pump pressure at the surface to an adequate pressure in the pay zone to cause the fractures to form. However, pressure is not the only requirement. Because of the extreme distance that the frac fluid must travel, in addition to the large number of perforations in the lateral run through which the frac fluid must flow, a very high volumetric flow rate must be achieved. Thus, a frac pump is typically called upon to continuously pump frac fluid at a maximum pressure of around 15,000 PSI with a maximum flow rate of over 1132 GPM downhole, depending on the rpm and plunger size, which requires an input power of upwards of 2,500 BHP to achieve this kind of performance from the pump.

Positive displacement frac pumps typically come in a triplex (three cylinder) or quintuplex (five cylinder) configuration. FIG. 1 depicts a typical quintuplex configuration, but is equally as representative of a triplex configuration as the only functional difference is an additional two cylinders. As depicted, the pump consists of a power end (102) and a fluid end (104). The power end includes a heavy steel block casing that houses the power components including: the input shaft that drives the bull gear, which is attached to the crank shaft, which is in turn attached to the plungers by crosshead/connecting rods. The fluid end (104) also includes a heavy steel block casing that houses the positive displacement plungers that work the frac fluid, drawing the fluid in through an intake manifold (106) and out under extreme pressure and flow rate through an output manifold (108). One-way valves within the fluid end (104) manage the flow. To handle such extreme operating conditions, each of these components must typically be forged from high strength alloy steel and, consequently, is exceedingly heavy.

Oil and gas wells are usually located in very remote locations, requiring preparation of well sites with private roads for access from state highways. Thus, to move frac pumps and supporting equipment to such locations it is necessary to prepare specialized trailers. FIG. 2 depicts a typical frac pump semi-trailer with the systems required for operation of the frac pump at a remote well site. The frac pump (202), although one of many components necessary for the fracturing process to take place, tends to be one of the heaviest component on the trailer and is positioned directly over the trailer axles. The frac pump (202) fluid end is connected to a frac fluid blender (204) through a series of piping and valves (206). A high-horsepower diesel engine (208) connects to the frac pump (202) power end input shaft through a transmission (210) and drive shaft. For continuous operation the diesel engine (208) is also provided with a cooling system (212) and a reserve of fuel (214). In all, the tractor, trailer, and components can very easily exceed the standard 80,000 LBS maximum road weight limit established by the U.S. and various state Department of Transportation offices for operation on public roadways. In fact, it is not uncommon for such a tractor/trailer combination to weigh as much as 100,000 LBS or greater, requiring costly special permits to transport over the roadways and reinforced semi-trailers having extra axles and wheels. The result is higher costs for the operator due to the permitting process, equipment purchase, and maintenance, as well as limited transportability due to the requirements for a sufficiently strong and durable roadway to deliver the rig to a well site.

What is needed is a way to reduce this overall weight without sacrificing the strength and integrity of the frac pump and support equipment. The present invention substantially reduces the overall weight of the frac pump assembly without compromising the torsional strength or balance of the rotating internal components. Further, the present invention also reduces the moment of inertia of the rotating internal components, thereby increasing overall efficiency and lowering the power consumption. Further still, the present invention achieves this in an unobtrusive fashion, such that it is not readily visible to the casual maintenance repairperson. Other benefits are taught herein, as will be readily appreciated following a reading and understanding of the following detailed description.

### BRIEF SUMMARY OF THE INVENTION

Disclosed herein is a lightened rotating member for a machine, the rotating member comprising: a plurality of radial penetrations, the radial penetrations formed around the circumference of at least one main bearing support journal. Another embodiment includes a plurality of radial penetrations, the radial penetrations formed around the circumference of each of a plurality of main bearing support journals. In another embodiment the radial penetrations are blind holes. In another embodiment the radial penetration centerlines are evenly spaced around the circumference. In another embodiment that includes an even number of evenly-spaced radial penetrations, there is at least one radial penetration dimension that differs in response to dynamic balancing of the rotating member. In another embodiment one or more grooves are formed around the circumference of the at least one main bearing support journal. Another embodiment includes a bearing race that is independently positional about the penetrated bearing support journal. Another embodiment includes a bearing race that is independently positional about the penetrated bearing support journal, wherein positioning of the bearing race substantially conceals the radial penetrations. In another embodiment the radial penetrations are configured to reduce the inertia of the rotating member without substantially reducing the torsional stability and balance of the rotating member.

Also disclosed is a method for lightening the weight of a rotating member of a positive displacement device, the method steps comprising: forming a plurality of radial penetrations around the circumference of at least one main bearing support journal. Steps in another embodiment include forming a plurality of radial penetrations around the circumference of each of a plurality of main bearing support journals. Steps in another embodiment include dynamically balancing the rotating member by varying the dimension of one or more of the radial penetrations. Steps in another embodiment include forming one or more grooves around the circumference of the at least one main bearing support journal. In another embodiment the radial penetrations are blind holes. In another embodiment the radial penetration centerlines are evenly spaced around the circumference. Steps in another embodiment include installing a bearing race that is independently positional about the penetrated bearing support journal. Steps in another embodiment include installing a bearing race that is independently positional about the penetrated bearing support journal, wherein positioning of the bearing race substantially conceals the radial penetrations. In another embodiment the radial penetrations are configured to reduce the inertia of the rotating member without substantially reducing the torsional stability and balance of the rotating member.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 is a perspective view of a typical quintuplex fracturing pump assembly;

FIG. 2 depicts a typical frac pump semi-trailer with the systems required for operation of the frac pump at a remote well site;

FIG. 3 depicts a perspective view of an embodiment of the present invention in the form of a crankshaft rotating-member separated from the power end housing of a frac pump for clarity;

FIG. 4 is an end axial view of the embodiment, highlighting the placement and spacing of the lightening penetrations;

FIG. 5 is an end axial view of another embodiment, highlighting the placement and spacing of a different number of lightening penetrations;

FIG. 6 depicts the embodiment with roller bearings installed on the main bearing journals; and

FIG. 7 depicts the interior of a frac pump, highlighting the construction and location of the crankshaft within the main bearing bores and webbing with the rotating member embodiment installed.

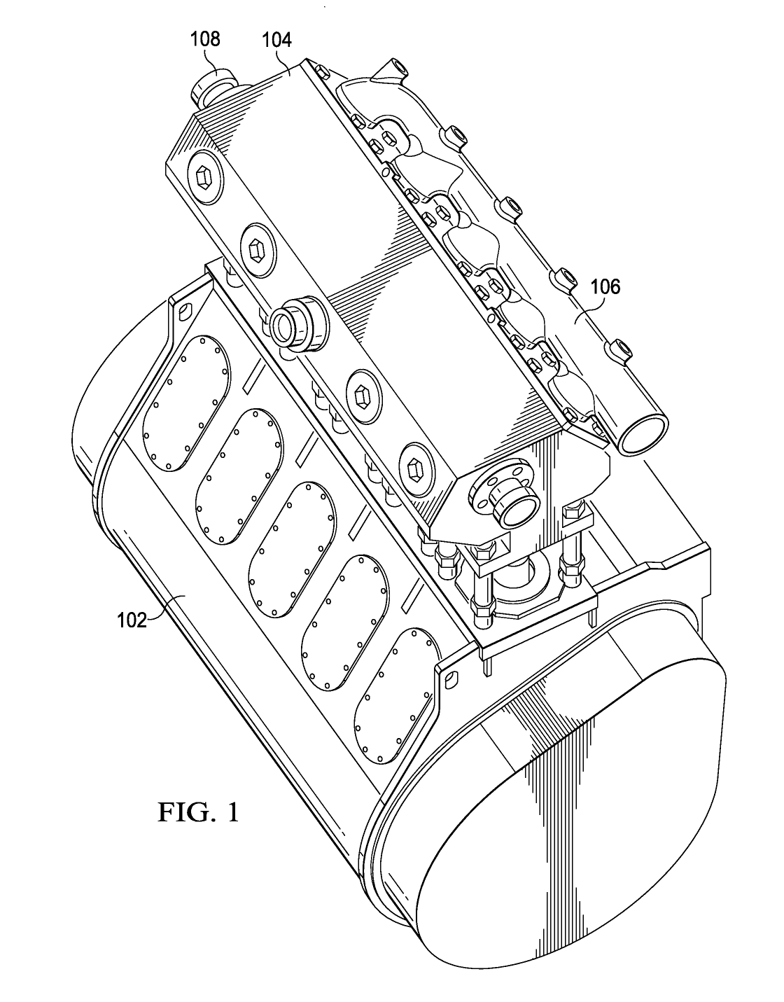

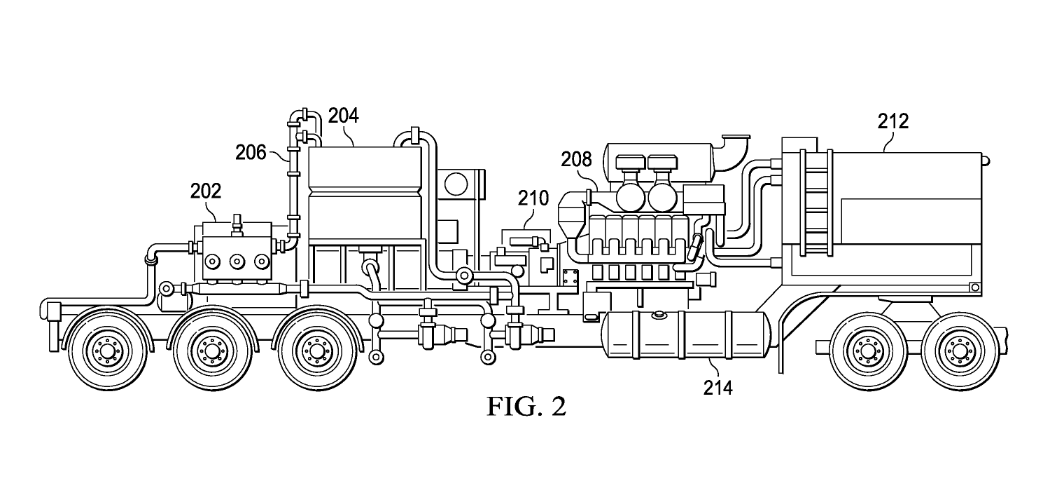

The above figures are provided for the purpose of illustration and description only, and are not intended to define the limits of the disclosed invention. Use of the same reference number in multiple figures is intended to designate the same or similar parts. Furthermore, if the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

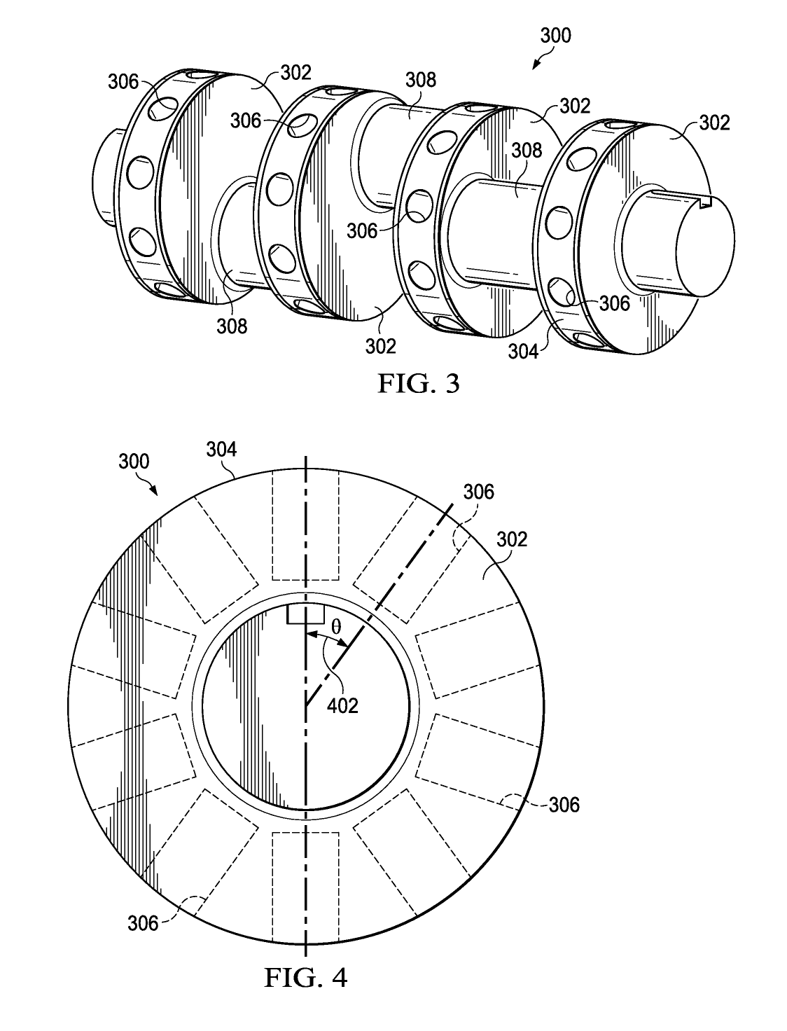

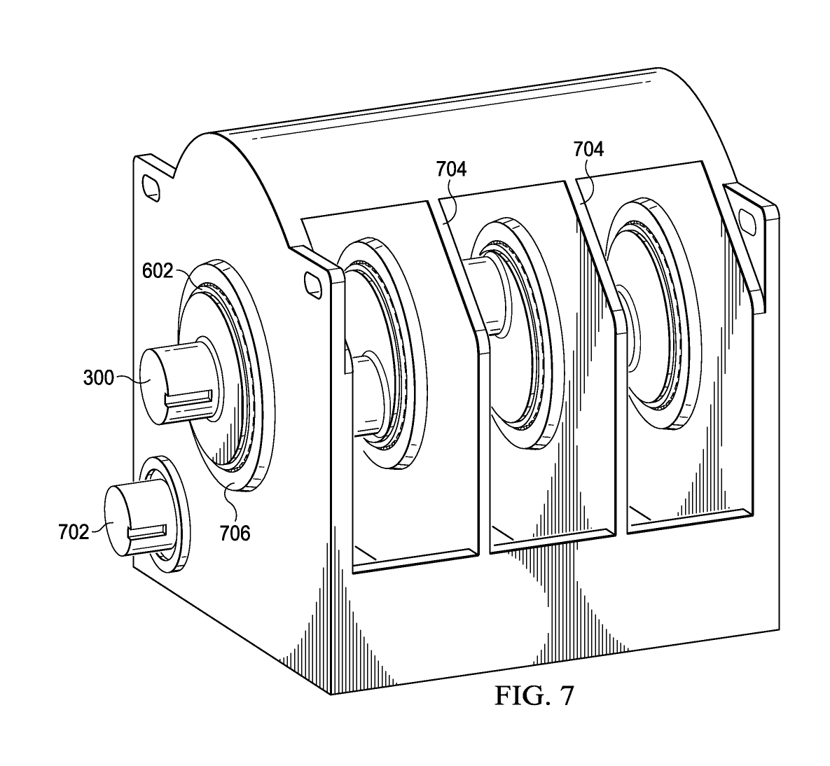

FIG. 3 depicts a perspective view of a first embodiment of a rotating member utilizing the present invention in the form of a crankshaft rotating-member separated from the power end housing of a frac pump. As shown, the crankshaft (300), in triplex configuration, features three rod bearing journals (308) supported by four main bearing journals (302). The main bearing journals have a bearing face (304) upon which an inner bearing race is mounted for a roller main bearing assembly (see FIG. 6). A plurality of blind hole penetrations (306) is formed in each bearing face (304) along the circumferential centerline. Although a triplex configuration is described for the present embodiment, other embodiments are possible and the same principles apply. For example, in a quintuplex configuration the crankshaft would have five rod bearing journals supported by at least six main bearing journals. One of ordinary skill in the art to which the invention pertains will appreciate that a rotating assembly having any number of main bearing support journals is within the scope of the claims herein.

The crankshaft (300) may be manufactured from alloy steel, cast materials, or forged materials, so long as sufficient material exists in the main bearing journal to allow for the removal of a portion of the material in the novel manner as disclosed herein. Accordingly, one of ordinary skill in the art to which the invention pertains will understand that the invention applies equally to rotating members manufactured from any material appropriate for the application. Moreover, one of ordinary skill will understand that the machining technique for forming the penetrations depends upon the material used, as well as the desired accuracy of the resulting penetrations. While certain materials may be machined, others may require formation of the penetrations during the casting or forging process.

FIG. 4 provides an end-on axial view of the embodiment, highlighting the placement and spacing of the lightening holes (306). As shown, the present embodiment utilizes ten penetrations in each main bearing journal bearing face (304), with each penetration equally spaced around the journal circumference on an angle (402) of 36 degrees in this embodiment. Each penetration is formed by machining the material to a fixed depth along the radius of the journal toward the axial centerline of the crankshaft to a depth that does not interfere with internal oiling passages that supply pressurized oil to the rod and/or main bearings during operation. This creates a blind hole for the penetration, which is subsequently left void of material so as to remove mass from the journal.

For the sake of balance it is important that the dimensions of each penetration be equal. Thus, the depth of each penetration should be no greater than the shallowest penetration with regard to potential interference with an oiling passage. However, in another embodiment one or more of the holes may differ in dimension, which may be tolerated by statically and/or dynamically balancing the rotating assembly once the formation of the penetrations is complete. Because the mass is reduced at the outer diameter of the journal, not only is the weight of the crankshaft reduced, but the overall inertia for the journal (and consequently, the crankshaft) is reduced as well. In the present embodiment the addition of ten penetrations in each main bearing journal reduces the overall weight of the rotating assembly (300) by approximately 200 to 300 LBS, resulting in a substantial weight reduction.

In yet another embodiment having no interfering main bearing journal oiling passages, it is possible to machine the radial penetrations completely through the axial centerline. However, such a configuration might impact the torsional stability of the rotating member, which might limit the amount of horsepower input that the member could handle. Another embodiment may utilize a combination of through-holes and blind holes within one or more journals so long as a proper static and dynamic balancing of the rotating member is performed. In yet another embodiment the journal bearing face (304) features one or more grooves machined around the diameter of the bearing face (304) to supplement the removal of material for the purposes described herein.

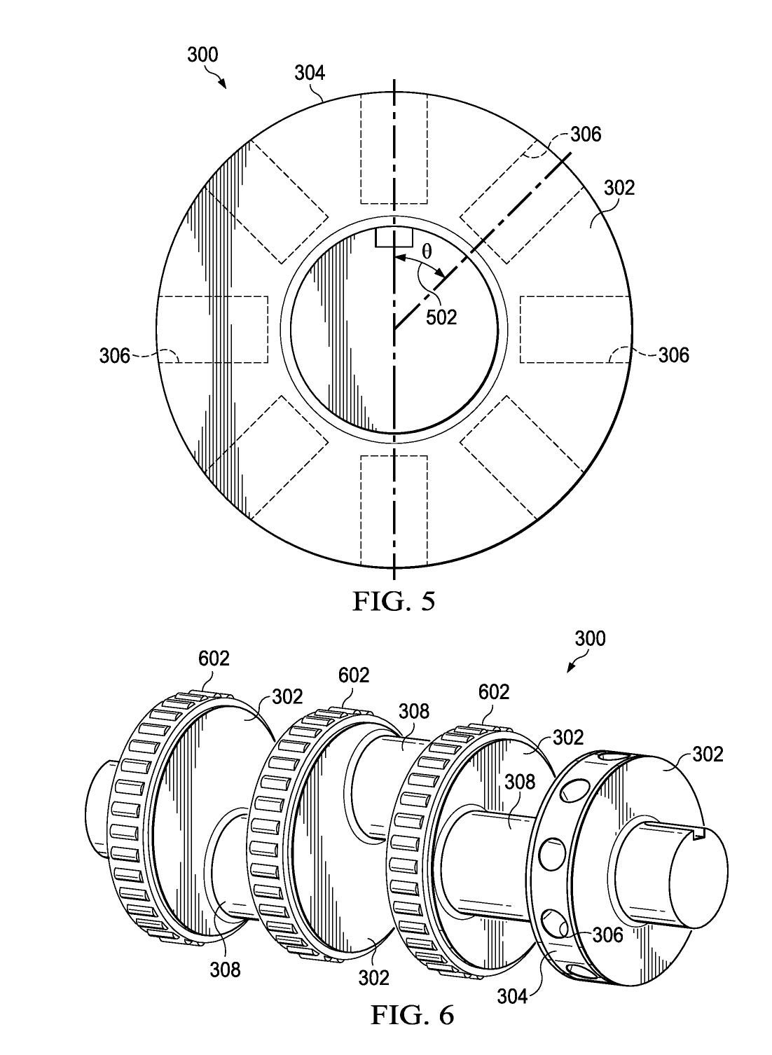

As previously stated, the plurality of penetrations (306) is equally spaced around the journal (304) circumference, along the journal bearing face (304) circumferential centerline. Other embodiments can have a greater or lesser number of penetrations and may even have certain journals without penetrations. For example, FIG. 5 depicts an end-on axial view of another embodiment, highlighting the placement and spacing of eight lightening penetrations, with the angle (502) between the centerline of each measuring approximately 45 degrees. In another embodiment twelve penetrations are utilized, with the angle between the centerline of each measuring 30 degrees. An even number of penetrations is utilized to ensure minimal effect on overall balance of the rotating assembly. However, other embodiments may utilize an odd number of radial penetrations if attention is given to the static and/or dynamic balance of the resulting rotating assembly.

FIG. 6 depicts the present embodiment of the rotating member with roller bearings (602) installed on the main bearing journals. When the roller bearings (602) are in place, the penetrations are essentially shielded from view. The roller bearing (602) features an inner bearing race that contacts the main bearing journal face (304), is independently positional about the journal face (304) surface, and covers the penetrations thereby keeping matter from accumulating therein. An outer bearing race is mounted in the power end housing (see FIG. 7). Although the present embodiment utilizes roller bearings along the main bearing journals, other configurations are possible and are within the scope of the invention. For example, another embodiment utilizes sleeve bearings instead of roller bearings. Use of sleeve bearings on internal rotating members is popular in the automotive industry. In such a configuration it may be necessary to add a chamfer to the penetration (306) outer lip to prevent shearing of the oil film from the bearing surface and subsequent galling or stripping off of the bearing material.

FIG. 7 depicts the interior of a frac pump housing (702), highlighting the construction and location of the crankshaft rotating member (300) embodiment within the main bearing bores and webbing (704). As shown, the rotating member (300) main bearings (602) roll within outer bearing races (706) that are mounted within bores in the main bearing webbing (704). These webs (704) provide positional support for the rotating member (300) and are dimensioned for adequate strength and rigidity to dissipate the tremendous forces generated within the frac pump during operation. The bearing face (304), during operation, supports the forces exhibited on the crankshaft by the reciprocating connecting rod/piston/plunger arrangement by transferring the compressive forces encountered by the plunger/piston/connecting rod assembly from the rod bearing journal (308) through the main bearing journal bearing face (304), the roller bearings (602), the outer bearing races (706), into the support webs (704) and ultimately to the power end housing (702) where the forces are dissipated.

Although the embodiment described herein focused on the crankshaft of a hydraulic fracturing pump as a rotating member that benefits from the methods and treatments taught herein, the invention is also applicable to other rotating members and other uses. For example, the frac pump pinion shaft (702) is supported within the housing by bearing journals as well. Machining radial lightening holes as taught herein in one or more of the bearing journal surfaces would, likewise, reduce overall pinion shaft weight and inertia without adversely affecting the pinion shaft's torsional strength. Pumps having similar rotating components that might benefit from the invention include concrete, water, and other well treatment pump devices.

Further still, internal combustion engines (gasoline, diesel, alternative fuels, or the like) would also benefit from the invention taught herein. For example, a typical internal combustion engine utilizes a crankshaft or rotor (i.e., rotary internal combustion engine) having main bearing journals for primary support. Machining radial lightening holes as taught herein in these main bearing journal surfaces would, likewise, lower the overall crankshaft weight and inertia without adversely impacting the torsional strength and balance of the overall rotating assembly. Other internal rotating members that are supported by main bearing journals (for example, the camshaft, counterbalance shaft, transmission input shaft, drive axles, etc.) would likewise benefit from this novel treatment.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

1. A lightened rotating member for a machine, the rotating member comprising:
a plurality of radial penetrations, the radial penetrations formed around the circumference of at least one main bearing support journal.

2. The lightened rotating member of claim 1, further comprising:
a plurality of radial penetrations, the radial penetrations formed around the circumference of each of a plurality of main bearing support journals.

3. The lightened rotating member of claim 1, wherein the radial penetrations are blind holes.

4. The lightened rotating member of claim 1, wherein the radial penetration centerlines are evenly spaced around the circumference.

5. The lightened rotating member of claim 1, further comprising:
an even number of evenly-spaced radial penetrations, wherein at least one radial penetration dimension differs in response to dynamic balancing of the rotating member.

6. The lightened rotating member of claim 1, further comprising:
one or more grooves formed around the circumference of the at least one main bearing support journal.

7. The lightened rotating member of claim 1, further comprising:
a bearing race that is independently positional about the penetrated bearing support journal.

8. The lightened rotating member of claim 1, further comprising:
a bearing race that is independently positional about the penetrated bearing support journal, wherein positioning of the bearing race substantially conceals the radial penetrations.

9. The lightened rotating member of claim 1, wherein the radial penetrations are configured to reduce the inertia of the rotating member without substantially reducing the torsional stability and balance of the rotating member.

10. A method for lightening the weight of a rotating member of a positive displacement device, the method steps comprising:
forming a plurality of radial penetrations around the circumference of at least one main bearing support journal.

11. The method of claim 10, the method steps further comprising:
forming a plurality of radial penetrations around the circumference of each of a plurality of main bearing support journals.

12. The method of claim 10, the method steps further comprising:
dynamically balancing the rotating member by varying the dimension of one or more of the radial penetrations.

13. The method of claim 10, the method steps further comprising:
forming one or more grooves around the circumference of the at least one main bearing support journal.

14. The method of claim 10, wherein the radial penetrations are blind holes.

15. The method of claim 10, wherein the radial penetration centerlines are evenly spaced around the circumference.

16. The method of claim 10, the method steps further comprising:
installing a bearing race that is independently positional about the penetrated bearing support journal.

17. The method of claim 10, the method steps further comprising:
installing a bearing race that is independently positional about the penetrated bearing support journal, wherein positioning of the bearing race substantially conceals the radial penetrations.

18. The method of claim 10, wherein the radial penetrations are configured to reduce the inertia of the rotating member without substantially reducing the torsional stability and balance of the rotating member.
